(19) United States
(12) Patent Application Publication
(10) Pub. No.: US 2003/0210696 A1
(43) Pub. Date: Nov. 13, 2003

(54) System and method for routing across segments of a network switch

(75) Inventor: Michael S. Goldflam, Wakeforest, NC (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(73) Assignee: GlobespanVirata Incorporated, Red Bank, NJ

(21) Appl. No.: 10/063,468

(22) Filed: Apr. 25, 2002

(51) Int. Cl. H04L 12/28

(52) U.S. Cl. 370/395.1

(57) ABSTRACT

A method and a system for using a network switch, such as in a gateway, to route frames between network segments are disclosed. Frames from one network segment can be provided to one of a plurality of ports of a network switch. The network switch provides the frames to a processor, whereupon the processor performs any higher-level processing of the frames, such as Internet Protocol Security (IPSec) or network address translation (NAT). After any applicable modification of the frame the processor provides the modified frame back to the network switch for output on a port associated with a network segment that includes the intended destination of the frame.

### BACKGROUND OF THE INVENTION

The present invention relates generally to providing connectivity between segments of a network, and more particularly to using a switch to route data between segments of a network.

When providing connectivity between various network components of one or more networks connected to a gateway, it is often desirable to segregate groups of one or more network components into separate subnets. By providing separate subnets, various higher-level functions or operations can be performed by the gateway on data transmitted between the subnets. For example, the gateway could place an email server in a different subnet than an intranet of personal computers, thereby providing a secure network segment (also known as a demilitarized zone or secure perimeter network) between the intranet of personal computers (PCs) and the email server. As a result, external network components can access the internal email server without being able to access the intranet of PCs. Likewise, segments of a network can be separated into different subnets to prevent a high data flow on one network segment from degrading the bandwidth of another network segment.

However, while providing separate subnets for different network segments provides a number of advantages, known implementations for routing across separate subnets often have a limited utility due to the increased cost and expense of implementing subnets. These known implementations typically utilize a separate network controller, such as a network interface card (NIC), for each subnet connected to a gateway. As a result, as the number of subnets increases, the cost and complexity of the gateway increases since additional network controllers must be added to the gateway.

In view of the limitations of known subnet routing implementations, an improved system and method for providing routing across network segments would be advantageous.

### SUMMARY OF THE INVENTION

The disclosed technique mitigates or solves the above-identified limitation in known implementations, as well as other unspecified deficiencies in the known implementations.

The use of Institute of Electrical and Electronics Engineers (IEEE) 802.1q tagging, IEEE 802.1 p priority fields, and VLAN capabilities of various Ethernet switch chips allows a host processor to route across the network interfaces of a switch chip. A host processor attached to a single interface of a switch chip can route across all interfaces by: identifying the interface that each frame is received from; directing the outgoing segment that each frame from the host processor must go out; and preventing the switch chip from directly forwarding frames between network interfaces.

Various implementations of the present invention can be adapted to utilize a switch chip by addressing three issues. First of all, the switch chip can be adapted to prevent the forwarding of data between the Ethernet segments directly. All frames are provided to, and processed by, the host processor. This includes unicast, multicast, and broadcast packets. Secondly, the switch chip is adapted to identify from which Ethernet segment a frame was received before passing data up through a network layer stack, such as Internet Protocol (IP). Lastly, implementations of the present invention generally identify the Ethernet segment by which the switch chip is to output frames from the host processor, including unicast, multicast, and broadcast packets.

In accordance with one embodiment of the present invention, a gateway for routing frames across multiple network segments is provided. The gateway comprises a processor, and a network switch coupled to the processor, the network switch having a plurality of ports, each port coupled to a network segment of a plurality of network segments. The network switch is adapted to provide at least one frame received by at least one port of the plurality of ports to the processor and to provide at least one frame received from the processor to at least one port of the plurality of ports based on an intended destination of the at least one frame.

In another embodiment, a system to route frames across a plurality of network segments is provided. The system comprises a processor, a network switch having at least three ports, the at least three ports including: a first port coupled to a first network segment; a second port coupled to a second network segment; and a third port coupled to the communications processor. The network switch is adapted to: associate a first indicator with a frame to generate a modified frame when the frame is received at the first port; associate a second indicator with a frame to generate a modified frame when the frame is received at the second port; provide the modified frame to the third port; provide a frame received at the third port to the first port when a first indicator is associated with the frame; and provide a frame received at the third port to the second port when a second indicator is associated with the frame. The communications processor is adapted to: receive a frame from the third port; determine an intended destination of the frame; associate the first indicator with the frame to generate a modified frame when the intended destination includes the first network segment; associate the second indicator with the frame to generate a modified frame when the intended destination includes the second network segment; and provide the modified frame to the third port.

In yet another embodiment, a system is provided, the system comprising a first network segment having at least one network component, a second network segment having at least one network component, and a gateway coupled to the first network and the second network. The gateway includes a processor having an interface, wherein the processor adapted to receive at least one frame via the interface, perform at least one routing operation on at least one frame received from the first interface, and provide the at least one frame for output on the first interface. The gateway further includes a network switch having a plurality of port, the network switch including a first port coupled to the interface of the processor, a second port coupled to the first network segment, and a third port coupled to the second network segment. The network switch is adapted to provide at least one frame received from the first port to the third port, to provide at least one frame received from the second port to the third port, to provide frames received from the third port to the first port for output to the first network segment when an intended destination of the at least one frame is a network component of the first network segment, and to provide at least one frame received from the third port to the second port for output to the second network segment when an intended destination of the at least one frame is a network component of the second network segment.

Additionally, in one embodiment a method to route at least one frame from a first network segment to a second network segment using a network switch coupled to a communications processor is provided. The method comprises the steps of receiving, at a first port of the network switch, a first frame from the first network segment, wherein an intended destination of the first frame includes the second network and providing the first frame to the communications processor via a second port of the network switch. The method further comprises modifying, at the communications processor, the first frame to generate a second frame, providing the second frame to the network switch via the second port, and providing the second frame to a third port of the network switch for output to the second network segment, wherein the third port is associated with the second network.

In yet another embodiment, a method for routing frames of data across switched Ethernet segments is provided. The method comprises the steps of receiving, at a first port of an Ethernet switch, a first frame from a first Ethernet segment, wherein the first port is assigned to a first VLAN and where the first frame is intended for receipt by a second Ethernet segment, and inserting a first indicator into the first frame to generate a first modified frame, the first indicator including a first VID value associated with the first VLAN. The method further comprises providing the first modified frame to a switch driver via a second port, wherein the second port is assigned to the first VLAN, removing the first indicator from the first modified frame to generate a second modified frame, and providing the second modified frame to an application stack via a first channel, wherein the first channel is associated with the first VID value. The method additionally comprises modifying, at the application stack, the second modified frame to generate a third modified frame, providing the third modified frame to the switch driver via a second channel, wherein the second channel is associated with a second VLAN, and where the second VLAN includes the second Ethernet segment. Furthermore, the method comprises inserting, at the switch driver, a second indicator into the third modified frame to generate fourth modified frame, wherein the second indicator includes a second VID associated with the second VLAN, providing the fourth modified frame to the network switch via the second port, removing, at the network switch, the second indicator from the fourth modified frame to generate a fifth modified frame, and providing the fifth modified frame to a third port for output to the second Ethernet segment, wherein the second port and the third port are assigned to the second VLAN.

One objective of at least one embodiment of the present invention is to allow a switch chip to be attached to a host processor to create a router that can route frames across each network interface attached to the switch chip. Another objective of at least one embodiment of the present invention is to minimize the cost of implementing subnets by reducing the number of network controllers necessary to support multiple subnets.

Still further features and advantages of the present invention are identified in the ensuing description, with reference to the drawings identified below.

### BRIEF DESCRIPTION OF THE DRAWINGS

The purposes and advantages of the present invention will be apparent to those of ordinary skill in the art from the following detailed description in conjunction with the appended drawings in which like reference characters are used to indicate like elements, and in which:

FIG. 1 is a block diagram illustrating a system for routing data across multiple network segments in accordance with at least one embodiment of the present invention;

FIG. 2 is a block diagram illustrating a mechanism for associating the ports of a network switch with different virtual local area networks in accordance with at least one embodiment of the present invention; and

FIG. 3 is a block diagram illustrating a mechanism for providing frames from one network segment to another network segment using virtual local area networks in accordance with at least one embodiment of the present invention.

### DETAILED DESCRIPTION OF THE PREFERRED EMBODIMENTS

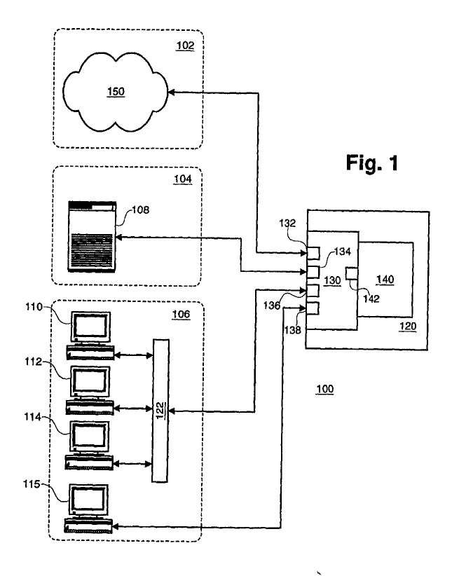

FIGS. 1-3 illustrate a method and a system for using a network switch to route frames between network segments. In at least one embodiment, one or more frames from one network segment are provided to one of a plurality of ports of a network switch. The network switch provides the each frame to a processor as it is received, whereupon the processor performs higher-level functions or operations on the frames, such as Internet Protocol Security (IPSec) or network address translation (NAT). After modifying the frame, if applicable, the processor provides the modified frame back to the network switch for output on a port connected to the intended destination of the frame. In at least one embodiment, the network switch utilizes port-based virtual local area networks (VLANs) to prevent frames received at one port of the network switch from being directly sent out another port. Additionally, the network switch can use the VLANs to indicate to the processor the particular port of the network switch at which the frame was received. Likewise, the processor can use the VLAN capability of the network switch to indicate to the network switch the particular port that is to be used to output a frame to a network segment attached to the port. One advantage of at least one embodiment of the present invention is that the cost of implementing multiple subnets can be reduced since a separate network controller is not necessary for each subnet.

The term frame, as used herein, refers to any logical segmentation of data transmitted over a networked medium, and usually includes a source address, a destination address, a data payload, and an error correction field, as well as various other fields. Additionally, frames can contain one or more other frames, such as one or more Internet Protocol packets included in an Ethernet frame. Examples of frames include Ethernet frames, IP packets, Asynchronous Transfer Mode (ATM) cells, and the like.

Referring now to FIG. 1, a system 100 for routing data across segments of a network switch 130 is illustrated in accordance with at least one embodiment of the present invention. The system 100 includes one or more subnets 102-106 connected to a gateway 120. The subnets 102-106 each can include one or more network segments having one or more network components, where a network component can include any component or device adapted to communicate with another component or device over a network, such as a server, a hub, a router, a bridge, a switch, a terminal, a PC, and the like. In the illustrated embodiment, the subnet 102 includes a wide area network (WAN) 150 and the subnet 104 includes a data server 108, such as a file transfer protocol (FTP) server or simple mail transfer protocol (SMTP) server. The subnet 106 includes two network segments, one including PCs 110-114 connected via a hub 122 to the gateway 120 and a PC 115 connected separately to the gateway 120. The number and type of subnets connected to the gateway 120 and/or the number and type of network components of the subnets are illustrated for exemplary purposes. The present invention may be implemented with any number or type of subnets and any combination of network components on a subnet using the guidelines provided herein.

The gateway 120 can include any of a variety of devices utilized to connect two or more networks or subnets together, such as a digital subscribe line (xDSL) modem, a firewall, a gateway, a router, a bridge, and the like. To illustrate, the gateway 120 can include a combination hub/router adapted to provide a communication link between the Internet (one embodiment of the WAN 150 of the subnet 102) and the network components of the subnets 104, 106. To facilitate communication between the WAN 150 and the subnets 102-106, in at least one embodiment, the gateway 120 includes a network switch 130 connected to a communications processor 140. In one embodiment, the switch 130, as illustrated, includes a plurality of ports 132-138, each coupled to one of the network segments or network components of the subnets 102-106. The ports 132-138 can include ports adapted to support any of a variety of network architectures, such as Ethernet, token ring, asynchronous transfer mode (ATM), and the like. One example of an appropriate switch 130 is an Ethernet switch having the trade designation KS8993 available from Kendin Communications, Inc. of Sunnyvale, Calif. As with the subnets, the number of ports of the switch 130 is exemplary. Implementations of the present invention can utilize network switches having any number of ports without departing from the spirit or the scope of the present invention.

The communications processor 140 can include any of a variety of processing devices adapted to modify frames of data for networking purposes, where modification of frames can include, but is not limited to, routing frames, switching frames, bridging frames, as well as performing higher-level functions, such as network address translation (NAT) or encryption. The communications processor 140, herein referred to as the processor 140, can include a processor specifically designed for communications processing, such as an application specific integrated circuit (ASIC), a general purpose processor adapted to execute a set of executable instructions appropriate for handling of network data, or a combination thereof. One such implementation includes a communications processor available under the trade designation Helium 200 from GlobeSpanVirata, Inc. of Red Bank, N.J. Alternatively, the processor 140 can be implemented as a combination of discrete logic components.

The gateway 120 can be adapted to perform a variety of functions within the system 100. For example, in one embodiment, the gateway 120 is adapted to route frames between separate subnets. To illustrate, the gateway 120 can be utilized to route frames from the network components of the subnets 104, 106 to the WAN 105 of the subnet 102, and vice versa. Likewise, the gateway 120 can be adapted to function as a bridge by bridging frames between network segments of the same subnet. In this case, frames received via the port 138 from the PC 115 can be bridged to the PC 110 via the port 136 and the hub 122. Frames from the PCs 110-114 likewise can be bridged to the PC 115 via ports 136, 138 of the gateway 120.

Additionally, the gateway 120 can perform various higher-level operations while switching/bridging/routing frames between network segments. For example, the gateway 120 can act as a firewall between the WAN 150 and the subnets 104,106 by providing network address translation (NAT) on frames from the subnets 104, 106 to the WAN 150 and on frames from the WAN 150 intended for one or more of the network components of the subnets 104, 106. Likewise, the gateway 120 can be adapted to implement the subnet 104 as a secure perimeter network, thereby allowing external access to the data server 108 from the subnet 102 without sacrificing the security of the subnet 106. The gateway 120 can be adapted to provide a variety of other higher-level functions, whereby a higher-level function, as defined herein, includes any function, process, or operation performed at Layer 3 (the Network layer) or higher of the Open Systems Interconnection (OSI) Network Model. Higher-level functions can include routing, NAT, Internet Protocol Security (IPSec), encryption, filtering, and the like.

In order to provide the routing, bridging, and other desired functionality of the gateway 120, in at least one embodiment, each frame received at any of the ports 132-138 is provided to the processor 140 via the port 142. The processor 140 then modifies the frame, if desired, and provides the modified frame back to the switch 130 for output on the port associated with the intended destination of the modified frame. The term modify, as utilized herein with respect to frames of data, can include any of a variety of functions or processes performed on a frame by the processor 140. To illustrate, the processor 140 typically modifies a frame when the source/destination IP address of the one or more IP packets of the frame are changed by the processor during a NAT operation. Likewise, the Ethernet frame can be altered by adding or removing IP frames. Similarly, when the gateway 120 is utilized to route data between the subnets 102-106, the frame and/or its payload is modified.

By routing frames through the processor 140, various higher-level functions can be provided that otherwise are generally not available from conventional network switches or bridges. The higher-level functions provided by the processor 140 can include frame/packet filtering, network address translation (NAT), IPSec, implementation of a firewall between the WAN 150 and the subnets 104,106, and the like. To illustrate, a frame received at port 132 that is intended for subnet 104 would be directly provided to port 134 if the switch 130 operated as a conventional network switch. However, since the switch 130 is adapted to provide the frame to the processor 140 in accordance with one implementation of the present invention, the processor 140 can perform a desired operation on the frame, such as NAT, before providing the frame back to the network switch 130 for output on port 134.

For example, a frame received by the switch 130 from the PC 115 via the port 138 is provided to the processor 140. The processor 140, noting the intended destination of the frame (PC 110, in this example), modifies/processes the frame by encrypting the payload of the frame, and provides the modified frame to the switch 130. Additionally, the processor 140 can associate an indicator with the modified frame that is used by the switch 130 to determine which of ports 132-138 the modified frame is to be output on. Using this indicator, the switch 130 determines that the intended destination of the frame is connected to the port 136 and therefore provides the modified frame to the port 136 for output to the PC 110 via the hub 122.

In another example, assume that a frame from the PC 115 is received by the switch 130 via the port 138, where the frame is intended for a data server on the WAN 150 of the subnet 102. The switch 130 then forwards the frame to the processor 140 via the port 142. In this example, the gateway 120 is implemented as a firewall between the WAN 150 and the subnets 104, 106. Accordingly, the processor 140 performs a NAT operation on the frame and provides the modified frame to the switch 130 along with an indicator that the frame is intended for output via the port 132. Based on this indicator, the switch 130 outputs the modified frame on the port 132 for reception by the data server on the WAN 150.

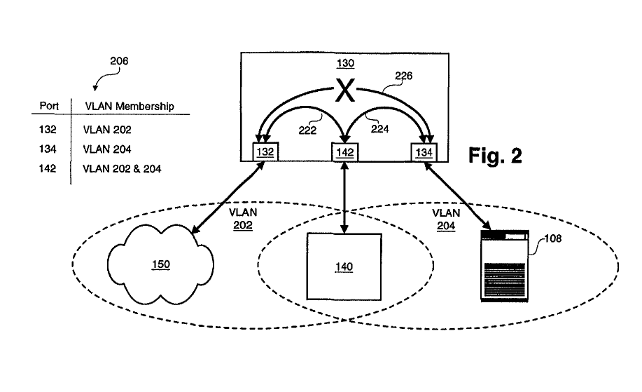

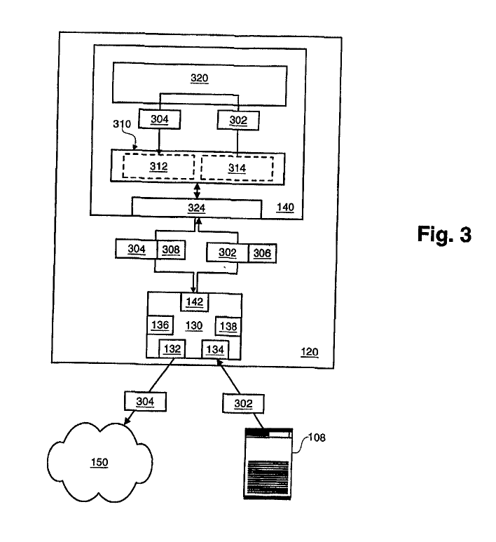

Referring now to FIGS. 2-3, various mechanisms to route data between the subnets 102-106 are illustrated in accordance with at least one embodiment of the present invention. For ease of illustration, various embodiments of the present invention are discussed herein in the context of Ethernet network architectures, such as 10BaseT, 100BaseT, 100BaseF, and the like. However, the present invention may be implemented using other network architectures known to those skilled in the art. Accordingly, any reference made herein to an Ethernet architecture also applies to other network architectures, unless otherwise noted.

Referring to FIG. 2, a mechanism to indicate the source port and/or destination port of a frame is illustrated. As discussed previously, in at least one embodiment, the switch 130 is adapted to provide all frames received at the ports 132-138 to the processor 140 for any additional processing and/or routing. In order to indicate the port at which a frame was received to the processor 140, the switch 130 can be adapted to associate and indicator value with the frame when the frame is provided to the processor 140. The processor 140 can then utilize this indicator value to determine the source port of the frame and handle the frame accordingly. Likewise, the processor 140 can be adapted to include an indicator with a frame that has been modified by the processor before the frame is provided back to the switch 130. The switch 130, in this case, uses the indicator to determine which of the ports 132-138 is to be used to output the frame to its intended destination.

In at least one embodiment, a virtual local area network (VLAN) scheme is utilized to provide the input port indicator and/or the output port indicator. In this case, the switch 130 is adapted to support port-based VLANs, such as a VLAN implementation in accordance with the IEEE 802.1q standard. In this case, the switch 130 can assign each of the ports 132-138 to a separate VLAN by the switch 130. In the illustrated embodiment, the port 132 is assigned to the VLAN 202 and the port 134 is assigned to the VLAN 204 (the ports 136, 138 and their associated subnet 106 of the exemplary implementation illustrated in FIG. 1 are omitted for ease of illustration). In general, network switches implementing VLANs are prevented from forwarding frames between ports having mutually exclusive VLAN memberships. Accordingly, since the port 132 belongs to a different VLAN than the port 134, there typically is no way for frames from the WAN 150 to be forwarded directly to the data server 108 by the switch 130. Likewise, due to mutually exclusive VLAN memberships, frames from the data server 108 are not forwarded directly to the WAN 150 by the switch 130.

However, since each of ports 132-138 has a mutually exclusive VLAN membership, frames typically are not directly switched between any of the ports 132-138 of the switch 130. Instead the switch 130 assigns the port 142 to all of the VLANs of the ports 132-138. As illustrated with reference to the VLAN membership table 206, port 132 is assigned to the VLAN 202, the port 134 is assigned to the VLAN 204, and the port 142 is assigned to both the VLAN 202 and the VLAN 204. Accordingly, any frame received via the port 132 is forwarded to the port 142 since the port 132 and the port 142 belong to the same VLAN 202. Likewise, any frame received via the port 134 is provided to the port 142 since they also share the same VLAN 204. As a result, all frames received at the ports 132, 134 are forwarded to the processor 140 via the port 142 and are prevented from being provided directly to the other port. To illustrate, the line 222 demonstrates that frames received at port 132 (from VLAN 202) are provided from the port 132 to the port 142 since they both are in the same VLAN. Likewise, frames from the port 142 intended for the WAN 150 can be forwarded from the port 142 to the port 132 due to their mutual VLAN membership. The line 224 illustrates a similar frame transfer between the data server 108 connected to the port 134 and the processor 134 connected to the port 142. Since the port 142 is a member of the VLAN 204, frames received at the port 134 can be forwarded to the port 142, and vice versa. However, as discussed, the switch 130, in one embodiment, is adapted to prevent the direct transfer (illustrated by line 226) of frames directly from the port 132 to the port 134 and from the port 134 to the port 132 since the ports 132, 134 are members of different VLANs.

Referring now to FIG. 3, an exemplary operation of the gateway 120 is illustrated in accordance with at least one embodiment of the present invention wherein a frame 302 from the server 108 is routed by the gateway 120 for delivery to the WAN 150. In the illustrated embodiment, the data server 108 provides an Ethernet frame (frame 302) to the gateway 120, where the frame 302 is intended for receipt by a network component on the WAN 150. Upon receipt of the frame 302, the switch 130 identifies the port (port 134) used to receive the frame and associates an indicator 306 with the frame 302 based on the identified port. The switch 130, in at least one embodiment, utilizes port-based VLANs, as discussed in FIG. 2, to assign a VLAN identification (VID) to the indicator 306 associated with the frame 302. In one implementation, the VID is added as an IEEE 802.1q VID value to the Tag Control Field following the source address field and the destination address field of the Ethernet frame. For example, the switch 130 could assign a VID of 1 to the VLAN 202 and a VID of 2 to the VLAN 204. Accordingly, any frame received via the port 132 is assigned a VID of 1 in the TCI field of the frame and a frame received via the port 134 is assigned a VID of 2 in its TCI field. Other methods of indicating a VLAN to which a certain frame belongs may be used without departing from the spirit or the scope of the present invention. Additionally, the switch 130 can provide other desired values to the indicator 306, such as an IEEE 802.1p priority value to indicate the priority of the frame. The processor 140 then can utilize this priority value to schedule the frame for modification/processing.

Since, in this example, the port 142 belongs to the same VLAN (VLAN 204, FIG. 2), the switch 130 provides the frame 302 (with the indicator 306) to the port 142 for output to the processor 140. The frame 302 is received at the processor 140 by an interface 324 implemented as part of, or connected to, the processor 140. In at least one embodiment, the interface 324 includes an Ethernet media access control (MAC) interface integrated as part of the processor 140 and the port 142 includes an interface compatible with the Ethernet MAC interface, such as a Media Independent Interface (MII). Certain implementations of the switch 130 can be adapted to convert one port into an interface compatible with an Ethernet MAC interface. For example, the switch 130 could include an Ethernet switch available under the trade name KS8995 from Kendin Communications, Inc. of Sunnyvale, California. This exemplary Ethernet switch includes five ports, where one of the five ports can be converted into a MII compatible with an Ethernet MAC interface. The four non-convertible ports can be implemented as the ports 132-138, and the fifth port can be converted to a MII for implementation as the port 142 to interface with the Ethernet MAC interface (one embodiment of the interface 324) of the processor 140.

In at least one embodiment, the processor 140 includes a switch driver 310 and an application stack 320 for handling and modifying frames received from the switch 130. The switch driver 310 includes a device driver for the switch 130 that is adapted to receive a frame from the interface 324, remove or disassociate any indicators, such as the indicator 306 from the frame, if necessary, and provide the frame to the application stack 320. The application stack 320 includes one or more protocol stacks, such as an Internet Protocol (IP) stack, as well as any higher-level application layers. The switch driver 310 and the application stack 320 can be implemented as software, firmware, hardware, or a combination therein. For example, in at least one embodiment, the switch driver 310 includes a first set of executable instructions and the application stack 320 includes a second set of executable instructions, both sets performed by the processor 140.

In order to route across all of the ports of the switch 130, the switch driver 310 generally must bind multiple channels to the application stack 320, one channel for each of the ports 132-138. Accordingly, in at least one embodiment, the switch driver 310 includes a virtual driver 312 associated with the port 132 and a virtual driver 314 associated with the port 134 (as well as other virtual drivers for the ports 136, 138 omitted for ease of illustration). Each of the virtual drivers 312, 314 is bound to the application stack 320 as a separate channel, resulting in a separate channel between the switch driver 310 and the application stack 320 for each of the ports 132,134. From the perspective of the application stack 320, two separate network interfaces are attached. Accordingly, the application stack 320 can route frames between the ports 132, 134 using the channels provided by the virtual drivers 312, 314.

Upon receipt of the frame 302 from the interface 324, the switch driver 310 can determine which one of the virtual drivers 312, 314 is associated with the port used to receive the frame 302. This can be accomplished by analyzing the indicator 306. For example, if the switch 130 placed a VID value representing VLAN 204 into the TCI of the frame 302, the switch driver 310 can access this value and determine the virtual driver associated with the VLAN 204, which, in this case, is the virtual driver 314. After the switch driver 310 identifies the virtual driver 314, the switch driver 310, in one embodiment, strips the indicator 306 from the frame 302 and provides the frame 302 to the application stack 320 for bridging/routing/switching and/or further processing. Alternatively, the switch driver 310 can remove any or all IP packets from the frame 302 and individually provide the IP packets to the application stack 320 via the virtual driver 314.

The application stack 320, in at least one embodiment, is adapted to provide one or more desired higher-level functions in addition to being adapted to route/bridge/switch frames. For example, the application stack 320 can perform NAT on the frame 302, filter the frame 302, encrypt the payload of the frame 302, add or remove IP packets from the frame 302, and the like. After the frame 302 is processed/modified by the application stack 320, the modified frame is provided over the appropriate channel to the switch driver 310 as modified frame 304. In this case, the channel associated with the destination address of the modified frame 304 (the address of the network component on WAN 150) is supported virtual driver 314. Accordingly, the application stack 310 provides the modified frame 304 to the switch driver 310 using the virtual switch driver 314.

It will be appreciated that in order for the switch 130 to forward the modified frame 304 to the appropriate port, the switch 130 must have an indication of the desired output port. Accordingly, in at least one embodiment, the switch driver 310 associates an indicator 308 with the modified frame 304. As with the indicator 306, the indicator 308, in one embodiment includes an IEEE 802.1q VID value in the TCI field of frame 304. However, unlike the indicator 306 which indicated the source port of the frame 302 to the switch driver 130, the indicator 308 instead indicates the destination port of the modified frame 304 to the switch 130. Since, in this case, the modified frame 304 was received via a channel provided by the virtual driver 314, the switch driver 310 can include the VID value associated with the virtual driver 314 as the indicator 308 (such as the VID of the VLAN 202 of FIG. 2). The switch driver 310 provides the modified frame 306, along with the indicator 308, to the port 142 of the switch 130 via the interface 324.

The switch 130, upon receipt of the modified frame 304, analyzes the indicator 308 to determine the output port to be used to output the modified frame 304. The indicator 308 of the modified frame 304, in this example, has a VID value associated with the VLAN 202, of which the ports 132, 142 are members. Since port 142 and the port 132 are members of the same VLAN, the switch 130 can remove or disassociate the indicator 308 from the modified frame 304 and provide the modified frame 304 to the port 132 for output to the WAN 150. Meanwhile, since the ports 134-138 are not members of the VLAN 202, the switch 130 avoids providing the frame 304 to the ports 134-138 for output.

It will be appreciated that the frame 302 can include one or more unicast packets, multicast packets, and/or broadcast packets. Since unicast packets are directed between one source and one destination network component, no modification of the previously discussed mechanism for routing across the ports of the switch 130 is necessary. However, since multicast and broadcast packets may involve more than one destination network component, further handling of such packets may be necessary. For example, in one embodiment, the application stack 320 can provide a copy of a broadcast or multicast packet over some or all of the channels to the switch driver 310, in effect sending multiple unicast packets to the switch driver 310. The switch driver 310 can then provide each copy to the switch 130 with an indicator (e.g., a VID) of the desired output port for the copy. Alternatively, the switch 130 could implement a separate broadcast VLAN that includes all of the ports 132-138. Accordingly, when the processor 140 receives a broadcast or multicast packet, the processor 140 can include an indicator having a VID of the broadcast VLAN and provide the packet/frame to the switch 130. The switch 130, noting the broadcast VID of the indicator, then can provide a copy of the received packet to each of ports 132-138 for output.

Although one mechanism to determine source and destination ports of a frame based on VLAN membership has been illustrated, other mechanisms may be utilized by those skilled in the art, using the guidelines provided herein. In an alternate embodiment, the switch 130 can include a managed network switch, whereby a learning table built by the switch 130 can be provided to the switch driver 310. Therefore, when a frame is received by the switch driver 310 from the switch 130, the switch driver 310 can determine the source port of the frame by using the source address of the frame and the learning table and provide the frame to the application stack 320 through the corresponding virtual driver. Likewise, when a frame is received by the switch 130 from the switch driver 310, the switch 130 can determine the appropriate output port of the switch 130 based on the destination address of the frame and from the learning table.

Other embodiments, uses, and advantages of the invention will be apparent to those skilled in the art from consideration of the specification and practice of the invention disclosed herein. The specification should be considered exemplary only, and the scope of the invention is accordingly intended to be limited only by the following claims and equivalents thereof.

What is claimed is:

1A. A gateway for routing frames across multiple network segments comprising:
a processor;
a network switch coupled to the processor, the network switch having a plurality of ports, each port coupled to a separate network segment, wherein the network switch is adapted to:
provide at least one frame received by least one port of the plurality of ports to the processor; and
provide at least one frame received from the processor to at least one other port of the plurality of ports based on at least one intended destination of the at least one frame.

2A. The gateway of claim 1A, wherein the network switch is further adapted to associate at least one indicator with the at least one received frame prior to providing the at least one frame to the processor, wherein the at least one indicator includes an identifier associated with a port of the network switch used to receive the at least one frame from a network segment.

3A. The gateway of claim 2A, wherein the indicator includes an IEEE 802.1q VID value.

4A. The gateway of claim 2A, wherein the processor is further adapted to utilize the indicator to identify a source port of the network switch in communication with a source of the at least one frame.

5A. The gateway of claim 2A, wherein the processor is adapted to remove the at least one indicator from the at least one frame.

6A. The gateway of claim 1A, wherein the processor is further adapted to associate at least one indicator with the at least one frame prior to providing the at least one frame to the network switch, wherein the at least one indicator includes an identifier representing at least one destination port in communication with the at least one intended destination.

7A. The gateway of claim 6A, wherein the at least one indicator includes an IEEE 802.1q VID value.

8A. The gateway of claim 6A, wherein the network switch is further adapted to utilize the at least one indicator to identify the at least one destination port of the network switch represented by the identifier, the at least one destination port being in communication with the at least one intended destination.

9A. The gateway of claim 6A, wherein the network switch is further adapted to remove the at least one indicator from the frame.

10A. The gateway of claim 1A, wherein the network switch includes an Ethernet switch.

11A. The gateway of claim 1A, wherein the processor is adapted to perform at least one higher-level function with the at least one frame.

12A. The gateway of claim 11A, wherein the higher-level function is one of a group consisting of: filtering, network address translation, IPSec, and providing a secure perimeter network.

1C. In a distributed network comprising a first network segment having at least one network component and a second network segment having at least one network component, a gateway coupled to the first network and the second network, the gateway comprising:
a processor having an interface, wherein the processor is adapted to:
receive at least one frame via the interface;
perform at least one higher-level function with at least one frame received from the interface; and
provide the at least one frame for output on the interface; and
a network switch having a plurality of ports, the network switch including:
a first port coupled to the first network segment;
a second port coupled to the second network segment; and
a third port coupled to the interface of the processor;
wherein the network switch is adapted to:
provide at least one frame received from the first port to the third port;
provide at least one frame received from the second port to the third port;
provide at least one frame received from the third port to the first port for output to the first network segment when an intended destination of the at least one frame is a network component of the first network segment; and
provide at least one frame received from the third port to the second port for output to the second network segment when an intended destination of the at least one frame is a network component of the second network segment.

2C. The gateway of claim 1C, wherein:
the first port is assigned to a first VLAN;
the second port is assigned to a second VLAN; and
the third port is assigned to the first VLAN and the second VLAN.

3C. The gateway of claim 2C, wherein the network switch is further adapted to associate at least one indicator with the at least one frame received at one of the first and second ports, the at least one indicator including:
a VID representative of the first VLAN when the at least one frame is received via the first port; and
a VID representative of the second VLAN when the at least one frame is received via the second port.

4C. The gateway of claim 3C, wherein the VID includes an IEEE 802.1q VID value.

5C. The gateway of claim 3C, wherein the processor is further adapted to disassociate the at least one indicator from the at least one frame.

6C. The gateway of claim 3C, wherein the processor includes:
an application stack; and
a switch driver coupled to the interface and coupled to the application stack via multiple channels, wherein the switch driver is adapted to provide the at least one frame to the application stack via a channel representing the VID of the at least one indicator.

7C. The gateway of claim 6C, wherein the application stack is adapted to perform the at least one higher-level function.

8C. The system of claim 7C, wherein the higher-level function is one of a group consisting of: filtering, network address translation, IPSec, and providing a secure perimeter network.

9C. The gateway of claim 2C, wherein the processor is further adapted to associate at least one indicator with the at least one frame prior to providing the at least one frame to the interface for output, the at least one indicator including:
a VID representative of the first VLAN when the first network segment includes at least one intended destination of the at least one frame; and
a VID representative of the second VLAN when the second network segment includes at least one intended destination of the at least one frame.

10C. The gateway of claim 9C, wherein the VID includes an IEEE 802.1q VID value.

11C. The gateway of claim 9C, wherein the processor includes:
an application stack; and
a switch driver coupled to the interface and the application stack via multiple channels, wherein the switch driver is adapted to:
receive at least one frame from the application stack over a channel representing the at least one intended destination of the at least one frame; and
associate the at least one indicator with the at least one frame, wherein the VID of the at least one indicator is representative of the channel.

12C. The gateway of claim 11C, wherein the application stack is adapted to perform the at least one higher-level function.

13C. The gateway of claim 12C, wherein the higher-level function is one of a group consisting of: filtering, network address translation, IPSec, and providing a secure perimeter network.

14C. The gateway of claim 1C, wherein the network switch is further adapted to associate at least one priority value with the at least one received frame.

15C. The gateway of claim 14C, wherein the at least one priority value includes at least one IEEE 802.1p priority value.

16C. The gateway of claim 1C, wherein the higher-level function is one of a group consisting of: filtering, network address translation, IPSec, and providing a secure perimeter network.

17C. The gateway of claim 1C, wherein the network switch includes an Ethernet switch.

18C. The gateway of claim 1C, wherein the third port includes a Media Independent Interface.

1D. In a distributed network comprising multiple network segments, a network switch having at least three ports, each port coupled to a separate network segment, the at least three ports including:
a first port coupled to a first network segment;
a second port coupled to a second network segment;
a third port coupled to a processor, where the first port is adapted for bi-directional communication between the third port and the first network segment and the second port is adapted for bi-directional communication between the third port and the second network segment; and
the network switch being adapted to:
associate a source indicator with a frame received from one of the first and second ports, the source indicator including an identifier representing the source of the frame; and
provide the frame and the source indicator to the processor via the third port.

2D. The network switch of claim 1D, wherein the identifier of the source indicator includes a VID associated with one of the first and second ports coupled to one of the first and second network segments having a source of the frame.

3D. The network switch of claim 2D, wherein the VID includes an IEEE 802.1q VID value.

4D. The network switch of claim 1D, the network switch further being adapted to:
receive the frame and a destination indicator associated with the frame from the processor, the destination indicator including at least one identifier representing at least one intended destination of the frame; and
provide the frame to the at least one intended destination via one or more of the first and second ports based on the destination indicator.

5D. The network switch of claim 4D, wherein the at least one identifier of the destination indicator includes at least one VID assigned to at least one of the first and second ports in communication with the at least one intended destination.

6D. The network switch of claim 5D, wherein the at least one VID includes at least one IEEE 802.1q VID value.

7D. The network switch of claim 1D, wherein the network switch includes an Ethernet switch.

1E. In a distributed network comprising multiple network segments coupled to a network switch, a processor coupled to the network switch, the processor being adapted to:
receive a frame and a source indicator associated with the frame from the network switch, the source indicator including a identifier representing a source of the frame;
associate a destination indicator with the frame, the destination indicator including at least one identifier representing at least one intended destination of the frame; and
provide the frame and the destination indicator to the network switch for output to the at least one intended destination.

2E. The processor of claim 1E, wherein the processor is further adapted to disassociate the first indicator from the frame prior to providing the frame and the second indicator to the network switch.

3E. The processor of claim 1E, wherein the identifier of the source indicator includes a VID associated with a port of the network switch in communication with the source of the frame.

4E. The processor of claim 3E, wherein the VID includes an IEEE 802.1q VID value.

5E. The processor of claim 1E, wherein the at least one identifier of the second indicator includes at least one VID assigned to at least one port of at least one network segment having the at least one intended destination.

6E. The processor of claim 5E, wherein the at least one VID includes at least one IEEE 802.1q VID value.

7E. The processor of claim 1E, wherein the processor is further adapted to determine the at least one intended destination of the frame.

8E. The processor of claim 1E, wherein the processor is further adapted to perform at least one higher-level function with the at least one frame.

9E. The processor of claim 8E, wherein the higher-level function is one of a group consisting of: filtering, network address translation, IPSec, and providing a secure perimeter network.

1F. A method to route at least one frame from a first network segment to a second network segment using a network switch coupled to a processor, the method comprising the steps of:
receiving, at a first port of the network switch, a frame from the first network segment, wherein an intended destination of the frame includes a network component on the second network;
providing the frame to the processor via a third port of the network switch;
associating, at the processor, a destination indicator with the frame, wherein destination indicator represents the second network segment; and
providing the frame to a second port of the network switch for output to the second network segment based at least in part on the destination indicator.

2F. The method of claim 1F, wherein the step of providing the frame to the processor includes associating a source indicator with the frame, wherein the source indicator represents the first network segment.

3F. The method of claim 2F, wherein the source indicator includes a VID representative of a VLAN associated with the first port and the second port.

4F. The method of claim 3F, wherein the VID includes an IEEE 802.1q VID value.

5F. The method of claim 4F, wherein the source indicator further includes an IEEE 802.1p priority value.

6F. The method of claim 2F, further including the step of disassociating, at the processor, the source indicator from the frame.

7F. The method of claim 1F, wherein the destination indicator includes a VID representative of a VLAN associated with the second port and the third port.

8F. The method of claim 7F, wherein the VID includes an IEEE 802.1q VID value.

9F. The method of claim 1F, wherein the step of providing the frame to the second port includes selecting the second port from a plurality of ports of the network switch based on the destination indicator.

10F. The method of claim 1F, further including the step of performing, at the processor, a higher-level function with the frame.

11F. The method of claim 10F, wherein the higher-level function is one of a group consisting of: filtering, IPSec, network address translation, and encryption.

12F. The method of claim 1F, wherein the network switch includes an Ethernet switch.
